(19) United States
(12) Patent Application Publication
(10) Pub. No.: US 2011/0197472 A1
(43) Pub. Date: Aug. 18, 2011

(54) PROCESS FOR PRODUCING CROSSLINKED MOLDED FOAM AND CROSSLINKED MOLDED FOAM

(75) Inventor: Katsuhiro Yamada, Chiba (JP)

(73) Assignee: Sumitomo Chemical Company, Limited, Tokyo (JP)

(21) Appl. No.: 13/125,198

(22) PCT Filed: Oct. 20, 2009
(86) PCT No.: PCT/JP2009/068305

§ 371 Date: Apr. 20, 2011

(30) Foreign Application Priority Data
Oct. 22, 2008 (JP) 2008-271670

(51) Int. Cl. A43B 7/14; B32B 5/20; B32B 3/26

(52) U.S. Cl. 36/88; 156/78; 428/316.6

(57) ABSTRACT

A process for producing a cross-linked foamed molded article using a lower mold having a tray-shaped recessed portion and an upper mold capable of closing the tray-shaped recessed portion, the process comprising the following steps: (1) a step in which a thermoplastic resin sheet (A) comprising a blowing agent and a crosslinking agent and a thermoplastic resin sheet (B) comprising a blowing agent and a crosslinking agent and differing in resin composition from the thermoplastic resin sheet (A) are stacked in the tray-shaped recessed portion and the upper mold and the lower mold are clamped to fill the tray-shaped recessed portion with the thermoplastic resin sheet (A) and the thermoplastic resin sheet (B); (2) a step in which the molds clamped are pressed and heated; and (3) a step in which the molds are opened to obtain a foamed molded article.

### TECHNICAL FIELD

The present invention relates to a process for producing a cross-linked foamed molded article and a cross-linked foamed molded article.

### BACKGROUND ART

Cross-linked foamed molded article are used for a wide range of applications including floor materials, sound insulating materials, heat insulating materials, footwear members (outer sole, midsole, insole, etc.) because of its characteristics such as light weight properties and heat insulating properties. As a cross-linked foamed molded article, there are known, for example, a cross-linked foamed molded article obtained by filling a composition comprising an ethylene-vinyl acetate copolymer, a blowing agent, and a cross-linking agent into a mold, and pressurizing and expanding it (for example, JP 3-002657 B), and a cross-linked foamed molded article obtained by filling a composition comprising an ethylene-α-olefin copolymer, a blowing agent, and a cross-linking agent into a mold, and pressurizing and expanding it (for example, JP 2005-314638 A).

However, the cross-linked foamed molded article of an ethylene-vinyl acetate copolymer described in JP 3-002657 B had problems of a large foam specific gravity and a low tensile strength at break. Meanwhile, the cross-linked foamed molded article of an ethylene-α-olefin copolymer described in JP 2005-314638 A was good in foam density and tensile strength at break, but adhesiveness in bonding the cross-linked foamed molded article with another member was insufficient because the ethylene-α-olefin copolymer had no polar group in its molecule. Consequently, there is known also a cross-linked foamed molded article obtained by mixing an ethylene-vinyl acetate copolymer and an ethylene-α-olefin copolymer in an arbitrary ratio, and further adding a blowing agent and a cross-linking agent, and pressurizing and expanding the resultant composition. However, such a foamed molded article, as compared with a cross-linked foamed molded article of an ethylene-α-olefin copolymer, adhesiveness to another member was improved, but foam specific gravity was large and tensile strength at break was reduced, and balance among foam density, tensile strength at break, and adhesiveness to another member was not necessarily sufficient.

As a process for improving the adhesiveness of a foamed article to another member, there is known a process of modifying the surface of a foamed molded article. For example, there is a process of laminating a cross-linked foamed molded article of an ethylene-vinyl acetate copolymer onto the surface of a cross-linked foamed molded article of an ethylene-α-olefin copolymer. However, this process has a problem of increasing a step.

### DISCLOSURE OF THE INVENTION

Under such circumstances, a problem to be solved by the present invention is to provide a process for producing a cross-linked foamed molded article, the surface of which is different in properties from the center of the foamed molded article, without a step of modifying the surface of the foamed molded article, and a cross-linked foamed molded article obtained by using the process.

That is, a first embodiment of the present invention relates to a process for producing a cross-linked foamed molded article by the use of a lower mold having a tray-shaped recessed portion and an upper mold capable of closing the tray-shaped recessed portion, which process comprises the following steps:
(1) a step of stacking a thermoplastic resin sheet (A) comprising a blowing agent and a cross-linking agent and a thermoplastic resin sheet (B) comprising a blowing agent and a cross-linking agent and differing in resin composition from the thermoplastic resin sheet (A) in the tray-shaped recessed portion, and clamping the upper mold and the lower mold to fill the tray-shaped recessed portion with the thermoplastic resin sheet (A) and the thermoplastic resin sheet (B),
(2) a step of pressurizing and heating the clamped molds, and
(3) a step of opening the molds to obtain a foamed molded article.

A second embodiment of the present invention relates to a cross-linked foamed molded article obtained by the above-mentioned production process.

A third embodiment of the present invention relates to a compressed cross-linked foamed molded article obtained by compression molding the cross-linked foamed molded article.

A fourth embodiment of the present invention relates to a footwear member, the footwear member comprising a layer formed of the above-mentioned cross-linked foamed molded article or compressed cross-linked foamed molded article.

A fifth embodiment of the present invention relates to a footwear comprising the above-described footwear member.

### BRIEF DESCRIPTION OF THE DRAWINGS

FIG. 1 is a schematic view illustrating the process of the present invention for producing a foamed molded article.

FIG. 2 is a schematic view illustrating the process of the present invention for producing a foamed molded article.

FIG. 3 is a schematic view illustrating the process of the present invention for producing a foamed molded article.

FIG. 4 is a schematic view illustrating the process of the present invention for producing a foamed molded article.

FIG. 5 is a schematic view illustrating the process of the present invention for producing a foamed molded article.

### DESCRIPTION OF REFERENCE NUMERALS

1 Lower mold
1a Press plate as a portion of lower mold
1b Cutting mold as a portion of lower mold
2 Upper mold
3 Press plate
4 Tray-shaped recessed portion
5a Thermoplastic resin sheet (A)
5b Thermoplastic resin sheet (B)
5c Thermoplastic resin sheet (C)

### EMBODIMENTS FOR CARRYING OUT THE INVENTION

The present invention provides a process for producing a cross-linked foamed molded article by the use of a lower mold having a tray-shaped recessed portion and an upper mold capable of closing the tray-shaped recessed portion, which process comprises the following steps:
(1) a step of stacking a thermoplastic resin sheet (A) comprising a blowing agent and a cross-linking agent and a thermoplastic resin sheet (B) comprising a blowing agent and a cross-linking agent and differing in resin composition from the thermoplastic resin sheet (A) in the tray-shaped recessed portion, and clamping the upper mold and the lower mold to fill the tray-shaped recessed portion with the thermoplastic resin sheet (A) and the thermoplastic resin sheet (B),

(2) a step of pressurizing and heating the clamped molds, and

(3) a step of opening the molds to obtain a foamed molded article.

In the present invention are used a thermoplastic resin sheet (A) comprising a blowing agent and a cross-linking agent and a thermoplastic resin sheet (B) comprising a blowing agent and a cross-linking agent and differing in resin composition from the thermoplastic resin sheet (A). Another sheet differing in resin composition from both of the thermoplastic resin sheet (A) and the thermoplastic resin sheet (B) can additionally be used. One or more thermoplastic resin sheets (A) and one or more thermoplastic resin sheets (B) are used. When two or more kinds of sheets differing in resin composition are used, there can be produced a cross-linked foamed molded article, one surface layer of which and the other surface layer opposing to that surface layer are different in composition, and a cross-linked foamed molded article, the opposite surface layers of which are of the same composition and an intermediate layer is different in composition from the surface layers.

Examples of the combination of a thermoplastic resin sheet (A) and a thermoplastic resin sheet (B) differing in resin composition from the thermoplastic resin sheet (A) include the following.
The thermoplastic resin sheet (A) is constituted of a thermoplastic resin (a), and the thermoplastic resin sheet (B) is constituted of a thermoplastic resin (b),wherein the thermoplastic resin (a) and the thermoplastic resin (b) are different from each other.
The thermoplastic resin sheet (A) is constituted of a thermoplastic resin (a), and the thermoplastic resin sheet (B) is constituted of a thermoplastic resin (a) and a thermoplastic resin (b).
The thermoplastic resin sheet (A) is constituted of a thermoplastic resin (a) and a thermoplastic resin (b), and the thermoplastic resin sheet (B) is constituted of a thermoplastic resin (a) and a thermoplastic resin (b), provided that the ratio of the thermoplastic resin (a) to the thermoplastic resin (b) in the sheet (B) is different from the ratio of them in the sheet (A).

Examples of the thermoplastic resin contained in each sheet include ethylene-based resins, ethylene-unsaturated ester-based copolymers, propylene-based resins, styrene-butadiene copolymers, ethylene-propylene-diene terpolymers, and isoprene polymers.

Hereinafter detailed explanations are given with regard to a case where the thermoplastic resin contained in the thermoplastic resin sheet (A) and that contained in the thermoplastic resin sheet (B) each include an ethylene-based resin and/or an ethylene-unsaturated ester-based copolymer having a monomer unit based on ethylene and a monomer unit based on at least one unsaturated ester selected from the group consisting of a carboxylic acid vinyl ester and an unsaturated carboxylic acid alkyl ester. In such a case, a resultant cross-linked foamed molded article is preferable as a footwear member.

As the ethylene-based resin, there can be used an ethylene-α-olefin copolymer, high-pressure low density polyethylene, high density polyethylene, and the like, and each of them is used singly or two or more of them are used in combination. Particularly in the case of using the foamed molded article of the present invention as a shoe sole member such as a midsole, an ethylene-α-olefin copolymer is preferably used from the viewpoint of increasing tensile strength at break.

The density of an ethylene-based resin is usually equal to or more than 880 kg/m³, and equal to or less than 960 kg/m³. It is preferably equal to or less than 940 kg/m³, more preferably equal to or less than 930 kg/m³, and furthermore preferably equal to or less than 925 kg/m³ from the viewpoint of enhancing the light weight properties of a foamed molded article. The density is measured by the immersion method described in JIS K7112-1980 after carrying out the annealing described in JIS K6760-1995.

The melt flow rate (MFR) of an ethylene-based resin is usually equal to or more than 0.01 g/10 min. and equal to or less than 20 g/10 min. It is preferably equal to or more than 0.05 g/10 min., and more preferably equal to or more than 0.1 g/10 min. from the viewpoint of increasing an expansion ratio. It is preferably equal to or less than 10 g/10 min., and more preferably equal to or less than 8 g/10 min. in terms of tensile strength at break. The MFR is measured by A method under conditions of a temperature of 190° C. and a load of 21.18 N in accordance with JIS K7210-1995. In the measurement of the MFR is usually used an ethylene-based resin in which about 1000 ppm of an antioxidant has been incorporated in advance.

Examples of the ethylene-α-olefin copolymer include ethylene-1-butene copolymers, ethylene-4-methyl-1-pentene copolymers, ethylene-1-hexene copolymers, ethylene-1-octene copolymers, ethylene-1-decene copolymers, ethylene-1-butene-4-methyl-1-pentene terpolymers, ethylene-1-butene-1-hexene terpolymers, and ethylene-1-butene-1-octene terpolymers. Particularly in the case of using a foamed molded article of the present invention as a shoe sole member such as a midsole, ethylene-1-butene copolymers, ethylene-1-hexene copolymers, and ethylene-1-butene-1-hexene terpolymers are preferable, and ethylene-1-butene-1-hexene terpolymers and ethylene-1-hexene copolymers are more preferable from the viewpoint of tensile strength at break.

An ethylene-α-olefin copolymer is produced by a known polymerization process using a known catalyst for olefin polymerization, for example, a slurry polymerization process, solution polymerization process, a bulk polymerization process, a gas phase polymerization process, and so on using a Ziegler-Natta catalyst or a complex type catalyst such as a metallocene type complex or a non-metallocene type catalyst.

An ethylene-α-olefin copolymer which is particularly preferably used is an ethylene-α-olefin copolymer having a molecular weight distribution equal to or more than 5 and an activation energy of flow equal to or more than 40 kJ/mol, which is described in JP 2005-314638 A.

The ethylene-unsaturated ester copolymer in the present invention is a copolymer having a monomer unit based on ethylene and a monomer unit based on at least one unsaturated ester selected from the group consisting of a carboxylic acid vinyl ester and an unsaturated carboxylic acid alkyl ester. Examples of the carboxylic acid vinyl ester include vinyl acetate, and vinyl propionate. Examples of the unsaturated carboxylic acid alkyl ester include methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate, and isobutyl methacrylate. The monomer unit based on an unsaturated ester contained in the ethylene-unsaturated ester copolymer may include a single kind of monomer unit or two or more kinds of monomer units.

Examples of the ethylene-unsaturated ester copolymer include ethylene-vinyl acetate copolymers, ethylene-methyl acrylate copolymers, ethylene-ethyl acrylate copolymers, ethylene-methyl acrylate-ethyl acrylate terpolymers, ethylene-methyl methacrylate copolymers, ethylene-ethyl methacrylate copolymers, and the like, preferably ethylene-vinyl acetate copolymers, ethylene-methyl acrylate copolymers, ethylene-ethyl acrylate copolymers, and ethylene-methyl methacrylate copolymers.

Examples of the process for producing the ethylene-unsaturated ester copolymer include a process of copolymerizing ethylene with an unsaturated ester under polymerization conditions of a polymerization pressure not less than 1000 kg/cm² and not more than 4000 kg/cm² and a polymerization temperature not less than 200° C. and not more than 300° C. in the presence of a radical generator in a vessel type polymerization reactor or a tubular polymerization reactor.

The melt flow rate (MFR) of an ethylene-unsaturated ester-based copolymer is usually equal to or more than 0.5 and equal to or less than 100 g/10 min. From the viewpoint of enhancing the strength of a cross-linked foamed molded article, it is preferably equal to or less than 50 g/10 min., more preferably equal to or less than 20 g/10 min., and furthermore preferably equal to or less than 10 g/10 min. Furthermore, from the viewpoint of increasing the expansion ratio of a cross-linked foamed molded article, it is preferably equal to or more than 1 g/10 min., and more preferably equal to or more than 2 g/10 min. The MFR is measured by A method under conditions of a temperature of 190° C. and a load of 21.18 N in accordance with JIS K7210-1995.

In an ethylene-unsaturated ester-based copolymer, the total content of a monomer unit based on a carboxylic acid vinyl ester and a monomer unit based on an unsaturated carboxylic acid alkyl ester is usually equal to or more than 5 and equal to or less than 45 wt %, preferably from the viewpoint of the strength of a cross-linked foamed molded article, equal to or less than 40 wt %, and more preferably equal to or less than 35 wt %, where the content of all the monomer units in the copolymer is considered as 100 wt %. Furthermore, from the viewpoint of adhesiveness to another member, the total content is preferably equal to or more than 10 wt %, and more preferably equal to or more than 15 wt %. The content is measured by a known method. For example, the content of a monomer unit based on vinyl acetate is measured in accordance with JIS K6730-1995.

Examples of a blowing agent usable in the present invention include a thermally decomposable blowing agent having a decomposition temperature equal to or higher than the melting points of the ethylene-based polymer and the ethylene-unsaturated ester-based copolymer.

Examples of the above include azodicarbonamide, azodicarboxylic acid barium, azobisbutyronitrile, nitrodiguanidine, N,N′-dinitrosopentamethylenetetramine, N,N′-dimethyl-N,N′-dinitrosoterephthalamide, p-toluenesulfonyl hydrazide, p,p′-oxybis(benzenesulfonyl hydrazide), azobisisobutyronitrile, p,p′-oxybisbenzenesulfonyl semicarbazide, 5-phenyltetrazole, trihydrazinotriazine, and hydrazodicarbonamide. Two or more of them may be used in combination. Among them, is preferred azodicarbonamide or sodium hydrogen carbonate. The compounding proportion of the blowing agent is usually 1 to 50 parts by weight and preferably 1 to 15 parts by weight, where the total amount of the ethylene-based polymer and the ethylene-unsaturated ester-based copolymer is considered as 100 parts by weight.

As the cross-linking agent usable in the present invention, there is preferably used an organic peroxide having a decomposition temperature equal to or higher than the flow starting temperatures of the ethylene-based polymer and the ethylene-unsaturated ester-based copolymer and examples of such an organic peroxide include dicumyl peroxide, 1,1-ditertiarybutylperoxy-3,3,5-trimethylcycohexane, 2,5-dimethyl-2,5-ditertiarybutylperoxyhexane, 2,5-dimethyl-2,5-ditertiarybutylperoxyhexyne, α,α-ditertiarybutylperoxyisopropylbenzene, tertiarybutylperoxy ketone, and tertiarybutylperoxy benzoate. The decomposition temperature of the cross-linking agent in the present invention is a one hour half-life temperature.

The process for producing a thermoplastic resin sheet (A) and a thermoplastic resin sheet (B) is as follows. First, the above-mentioned ethylene-unsaturated ester-based copolymer and/or the ethylene-based resin, the blowing agent, and the cross-linking agent are compounded in at a prescribed proportion, and they are melt-mixed with a mixing roll, a kneader, an extruder or the like at a temperature at which neither the blowing agent nor the cross-linking agent decomposes, affording a resin composition. Secondly, the resin composition is molded into a sheet form with a roll kneader or the like. The thermoplastic resin sheet (A) and the thermoplastic resin sheet (B) are made so as to differ in resin composition from each other. For example, an ethylene-unsaturated ester-based copolymer and an ethylene-based resin are compounded so that the proportions thereof in one sheet may differ from those in the other sheet.

In producing a resin composition for forming a thermoplastic resin sheet, a blowing aid may be compounded as needed. Examples of the blowing aid include a compound having urea as a main component; a metal oxide such as zinc oxide and lead oxide; and a higher fatty acid such as salicylic acid and stearic acid; a metal compound of the higher fatty acid. The amount of the blowing aid to be used is preferably 0.1 to 30 wt %, and more preferably 1 to 20 wt %, where the total of the blowing agent and the blowing aid is considered as 100 wt %.

Furthermore, in producing a resin composition for forming a thermoplastic resin sheet, there can as needed, be compounded various additives such as cross-linking aids, heat-resistant stabilizers, weather-resistant agents, lubricants, antistatic agents, fillers and pigments (e.g., metal oxides such as zinc oxide, titanium oxide, calcium oxide, magnesium oxide, and silicon oxide; carbonates such as magnesium carbonate, and calcium carbonate; fiber materials such as pulp), and a rubber component and the like can also be compounded as needed.

In the present invention are used a thermoplastic resin sheet (A) and a thermoplastic resin sheet (B), which differ in resin composition from each other. In the case of using an ethylene-unsaturated ester-based copolymer and/or an ethylene-based copolymer as a thermoplastic resin, the ester group concentration of the thermoplastic resin sheet (A) is preferably higher than that of the thermoplastic resin sheet (B). Herein, “the ester group concentration of the thermoplastic resin sheet (A) is higher than that of the thermoplastic resin sheet (B)” includes a case that the ester group concentration of the thermoplastic resin sheet (B) is zero.

The ester group concentrations in the thermoplastic resin sheet (A) and the thermoplastic resin sheet (B) are measured by the use of an ATR, which is a kind of infrared spectroscopy. For example, a vinyl acetate concentration can be measured by the method described on page 601 of Polymer Analysis Handbook (issued by Kinokuniya Co., Ltd. and edited by the Division of Polymer Analysis and Characterization of the Japan Society for Analytical Chemistry).

The ester group concentration in each thermoplastic resin sheet can be controlled by adjusting the ester group concentration in the ethylene-unsaturated ester-based copolymer used or the amount of the ethylene-unsaturated ester-based copolymer contained in the resin composition used for producing the thermoplastic resin sheet.

When a thermoplastic resin sheet (A) is used so as to become at least one surface layer of a resulting cross-linked foamed molded article, the cross-linked foamed molded article becomes superior in adhesiveness to another member.

The ester group concentration in the thermoplastic resin sheet (A) is preferably 1 to 15 wt % from the viewpoint of enhancing adhesiveness to another member, and preferably not more than 10 wt % from the standpoint of further enhancing the strength of a cross-linked foamed molded article. From the viewpoint of further enhancing the adhesiveness to another sheet (for example, thermoplastic resin sheet (B)) laminated with the thermoplastic resin sheet (A) in producing the cross-linked foamed molded article, the ester group concentration in the thermoplastic resin sheet (A) is preferably not less than 2 wt %.

The ester group concentration of the thermoplastic resin sheet (B) is preferably lower than the ester group concentration of the thermoplastic resin sheet (A). The ester group concentration of the thermoplastic resin sheet (B) is preferably equal to or less than 5 wt % from the viewpoint of further enhancing the tensile strength at break of a cross-linked foamed molded article and reducing the density thereof. The thermoplastic resin sheet (B) may not contain an ethylene-unsaturated ester-based copolymer.

In order to obtain a cross-linked foamed molded article superior in balance among tensile strength at break, density and adhesiveness to another member, it is preferable to use a thermoplastic resin sheet (A) and a thermoplastic resin sheet (B) satisfying the following requirements (i) and (ii):

(i) the ester group concentration of the thermoplastic resin sheet (A) is equal to or more than 4%,

(ii) the ester group concentration of the thermoplastic resin sheet (A) is at least twice higher than the ester group concentration of the thermoplastic resin sheet (B), or the ester group concentration of the thermoplastic resin sheet (B) is 0.

When a thermoplastic resin sheet (A) and a thermoplastic resin sheet (B) as states above are used, there can be obtained a cross-linked foamed molded article in which an ethylene-based resin and an ethylene-unsaturated ester-based copolymer having a monomer unit based on ethylene and a monomer unit based on at least one unsaturated ester selected from a carboxylic acid vinyl ester and an unsaturated carboxylic acid alkyl ester have been cross-linked, and which satisfies the following requirements (i) and (ii):

(i) an ester group concentration of a surface of the foamed article is equal to or more than 4%,

(ii) the ester group concentration of a surface of the foamed article is at least twice higher than an ester group concentration of a center portion of the foamed article, or the ester group concentration of a center portion of the foamed article is 0.

A foamed article as stated above is superior in balance among tensile strength at break, density and adhesiveness to another member.

In the present invention, a cross-linked foamed molded article is produced using a pair of molds. The paired molds are a lower mold having a tray-shaped recessed portion and an upper mold capable of closing the tray-shaped recessed portion.

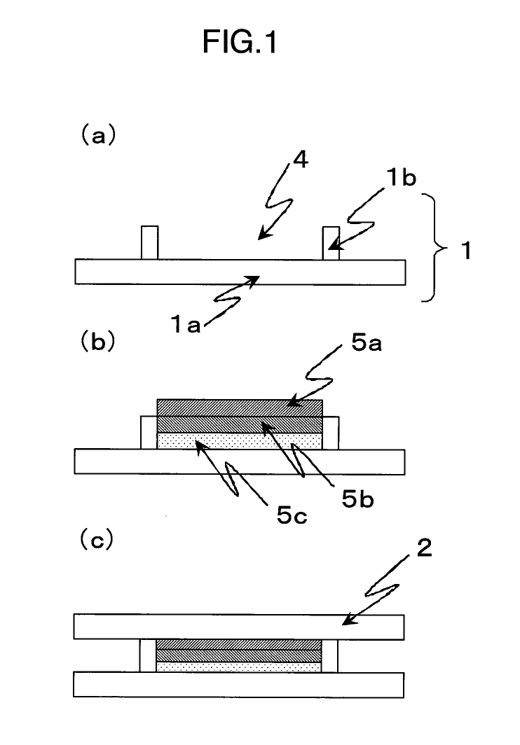

Examples of the molds are explained with reference to the drawings. FIG. 1(a) shows a lower mold comprising a press plate (1a) and a cutting mold (1b) placed thereon. The shape cutting mold (1b) is not limited in shape and one example thereof is a mold (1b) a cross-section of which taken by cutting the mold (1b) parallel to the press plate (1a) in the state shown in FIG. 1(a) is a circle, rectangle or square. As the upper mold capable of closing a tray-shaped recessed portion, there can be used a plate-shaped upper mold as shown in FIG. 1(c).

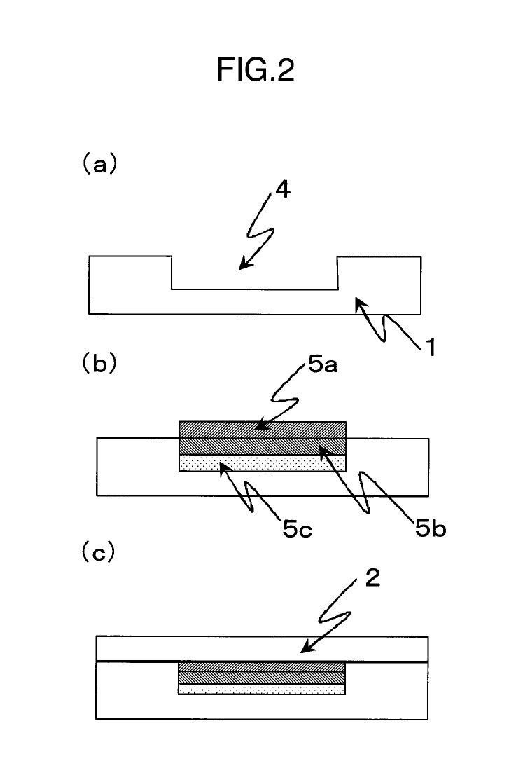

FIG. 2 shows a case in which a press plate as a lower mold has a tray-shaped recessed portion.

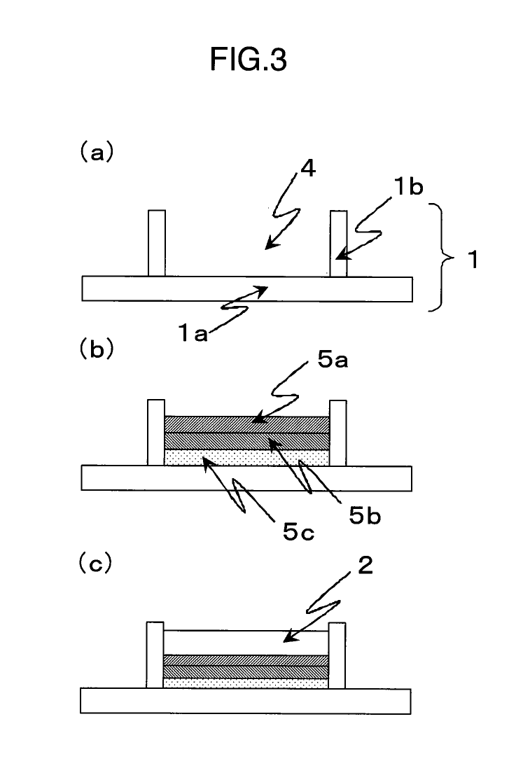

In the molds shown in FIG. 3, the lower mold has a shape similar to that of the lower mold shown in FIG. 1, and the upper mold has a shape capable of being fitted into the lower mold.

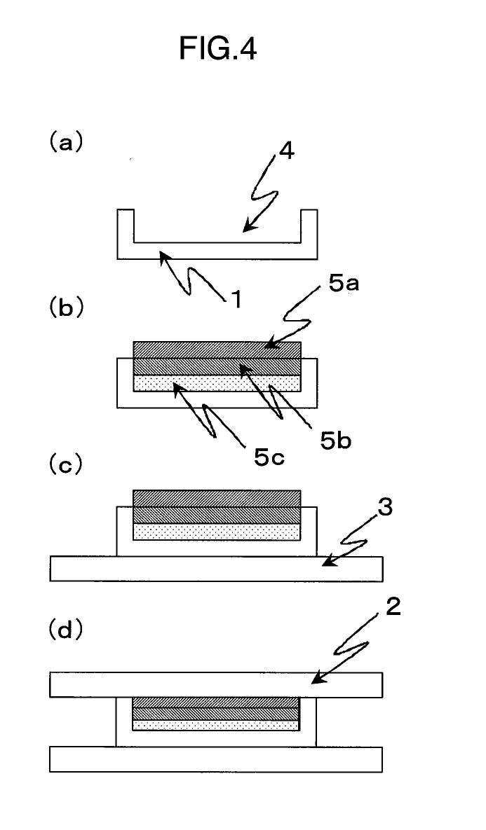

The molds shown in FIG. 4 are a tray-shaped lower mold and a plate-shaped upper mold. FIG. 4 shows a process of producing a foamed molded article by placing the tray-shaped lower mold on a press plate.

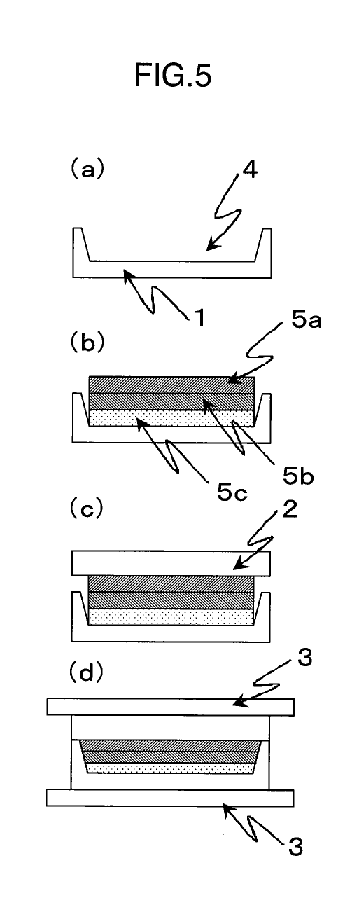

FIG. 5 shows a tray-shaped tapered lower mold and a plate-shaped upper mold. FIG. 5 shows a process of producing a foamed molded article by further sandwiching these molds between press plates.

Because of the use of a lower mold having a tray-shaped recessed portion and an upper mold capable of closing the tray-shaped recessed portion, a plate-shaped cross-linked foam can be obtained.

A lower mold having a tray-shaped recessed portion with an inner wall tapered as shown in FIG. 5 is preferred in order to improve the mold releasability of a cross-linked foamed molded article.

The depth of the tray-shaped recessed portion is usually 5 to 100 mm. The bottom shape of the tray-shaped recessed portion is usually an approximate square or a rectangle, the length of one side of which is 120 to 2000 mm.

Preferably, the paired molds can be temperature controlled independently. Preferably, the paired the molds to be used have been preheated in advance.

In the present invention, a cross-linked foamed molded article is produced by the use of the pair of the molds as stated above by a method comprising the following:

(1) a step of stacking a thermoplastic resin sheet (A) comprising a blowing agent and a cross-linking agent and a thermoplastic resin sheet (B) comprising a blowing agent and a cross-linking agent and differing in resin composition from the thermoplastic resin sheet (A) in the tray-shaped recessed portion provided by the lower mold, and clamping the upper mold and lower mold to fill the tray-shaped recessed portion with the thermoplastic resin sheet (A) and the thermoplastic resin sheet (B),

(2) a step of pressurizing and heating the clamped molds, and

(3) a step of opening the molds to obtain a foamed molded article.

The step (1) is a step of stacking a thermoplastic resin sheet (A) comprising a blowing agent and a cross-linking agent and a thermoplastic resin sheet (B) comprising a blowing agent and a cross-linking agent and differing in resin composition from the thermoplastic resin sheet (A) in the tray-shaped recessed portion of the lower mold, and clamping the upper mold and the lower mold to fill the tray-shaped recessed portion with the thermoplastic resin sheet (A) and the thermoplastic resin sheet (B). Preferably, the paired molds are preheated. In the case that the thermoplastic resin sheet (A) and the thermoplastic resin sheet (B) each comprises an ethylene-unsaturated ester-based copolymer and/or an ethylene-based resin as a thermoplastic resin, it is preferable to use the molds heated at 130 to 200° C.

In the tray-shaped recessed portion of the lower mold, one or more thermoplastic resin sheets (A) each having an area as large as about 0.8 to 1.0 time the bottom area of the recessed portion are placed. A thermoplastic resin sheet (B) differing in resin composition from the thermoplastic resin sheets placed in advance is superimposed thereon. One or more thermoplastic resin sheets (A) having the same resin composition as that of the bottom sheet are, as needed, placed further on the sheet (B). A plurality of thermoplastic resin sheets (A) and a plurality of thermoplastic resin sheets (B) may be respectively used.

In another possible embodiment, a thermoplastic resin sheet (A), a thermoplastic resin sheet (B), and as needed, another thermoplastic resin sheet (A) are stacked in this order in advance and then they are placed in the tray-shaped recessed portion.

When the amount of the thermoplastic resin sheets filled into the tray-shaped recessed portion is small, a resulting foamed article sometimes suffers from deterioration of its appearance, such as generation of voids. Meanwhile, when the amount of the sheets filled is excessively large, the appearance of a foamed article may be deteriorated, for example, a molten resin overflows out of the molds during foam molding, and this portion forms weld flash causing cracks during foaming. Preferably, the amount of the thermoplastic resin sheets filled into the tray-shaped recessed portion is approximately (the volume of the tray-shaped recessed portion [cm³])×(the specific gravity of the sheets [kg/cm³])×1.0 to 1.2.

While clamping the upper mold and the lower mold, the tray-shaped recessed portion is filled with thermoplastic resin sheets. Just after the filling, the wall surface of the recessed portion may not be in contact with the thermoplastic resin sheets.

For example, on the bottom surface of the tray-shaped recessed portion of the lower mold are placed one or more thermoplastic resin sheets (A), and thereon are placed one or more thermoplastic resin sheets (B), and furthermore on the thermoplastic resin sheets (B) are placed one or more thermoplastic resin sheets (A). By filling the thermoplastic resin sheets (A) and thermoplastic resin sheet (B) while stacking them so that the thermoplastic resin sheets (A) may be on both sides, namely, on the bottom side of the tray-shaped recessed portion and the side coming into contact with the upper mold, and the thermoplastic resin sheet (B) may be positioned between the thermoplastic resin sheets (A) as stated above, there can be produced a cross-linked foamed molded article in which the compositions of both surfaces are different from the composition of the center portion. In the case of producing a cross-linked foamed molded article in this way, a cross-linked foamed molded article superior in balance among tensile strength at break, specific gravity, and adhesiveness to another member can be obtained by the use of sheets in which thermoplastic resin sheets (A) and a thermoplastic resin sheet (B) each contain an ethylene-unsaturated ester-based copolymer and/or an ethylene-based resin as a thermoplastic resin and the ester group concentration of the thermoplastic resin sheets (A) is higher than the ester group concentration of the thermoplastic resin sheet (B). In order to obtain a cross-linked foamed molded article further superior in that balance, it is preferred that the ester group concentration of the thermoplastic resin sheets (A) be equal to or more than 4% and also be at least twice higher than the ester group concentration of the thermoplastic resin sheet (B) or that the ester group concentration of the thermoplastic resin sheet (B) is 0. In order to obtain a cross-linked foamed molded article superior in adhesiveness to another member, it is preferred that in the thickness of all the thermoplastic sheets filled, the proportion of accounted for by the thickness of each of the thermoplastic resin sheets (A) be adjusted to equal to or more than 15% and the proportion accounted for by the thickness of the thermoplastic resin sheet (B) be adjusted to equal to or less than 70%. In order to obtain a cross-linked foamed molded article superior in tensile strength at break and light weight properties, the proportion accounted for by the thickness of the thermoplastic resin sheet (B) be adjusted to equal to or more than 10% and the proportion accounted for by the thickness of each of the thermoplastic resin sheet (A) be adjusted to equal to or less than 80%.

The step (2) is a step of pressurizing and heating the clamped molds. The molds are clamped and pressurized by means of a pressing machine or the like. Usually, they are held for 10 to 60 minutes under the application of a load of 50 to 300 kgf/cm² at a temperature condition of 130 to 200° C. By pressurizing and heating the molds, the thermoplastic resin sheets are melted and the tray-shaped recessed portion is thoroughly filled with them.

By pressurizing and heating the molds for a prescribed time and then opening the molds, a cross-linked foamed molded article can be obtained (step (4)). The expansion ratio of the resulting cross-linked foamed molded article is usually 3 to 30. The expansion ratio is calculated by dividing <the specific gravity of the cross-linked foamed molded article after expansion> by <the specific gravity of the thermoplastic resin sheets before expansion>.

It is also permissible to produce a compressed cross-linked foamed molded article by further compression molding the cross-linked foamed molded article obtained by the above process. More specifically, in the above compression molding, the cross-linked foamed molded article obtained is sliced into a prescribed thickness and is held usually for 5 to 60 minutes under the application of a load of 30 to 200 kg/cm² at a temperature condition of 130 to 200° C., thereby being compressed to 20 to 90% of the original thickness. Particularly in the case of using the cross-linked foamed molded article of the present invention as a midsole, which is a kind of members for footwear, it is preferable to use a compressed cross-linked foamed molded article.

Preferably, the cross-linked foamed molded article and the compressed cross-linked foamed molded article obtained by the present invention satisfy the following requirements (i) and (ii):
(i) the ester group concentration of the surface of the foamed article is equal to or more than 4%,
(ii) the ester group concentration of the surface of the foamed article is at least twice higher than the ester group concentration of the center portion of the foamed article, or the ester group concentration of the center portion of the foamed article is 0.

This means that the surface of the cross-linked foamed molded article, which contributes to adhesiveness to another member, is high in ester group concentration. The ester group concentration of the surface of the foamed molded article and that of the center portion of the foamed molded article are measured by the use of ATR, which is a kind of infrared spectroscopy similarly to the ester group concentration of a surface of the sheet previously mentioned. For example, a vinyl acetate concentration can be measured by the method described on page 601 of Polymer Analysis Handbook (issued by Kinokuniya Co., Ltd. and edited by the Division of Polymer Analysis and Characterization of the Japan Society for Analytical Chemistry).

The cross-linked foamed molded article and the compressed cross-linked foamed molded article may also be cut into a desired shape or subjected to buffing.

The cross-linked foamed molded article and the compressed cross-linked foamed molded article of the present invention each can be used as laminates in which they have been laminated with other members. Examples of the material constituting the other members include vinyl chloride resin material, styrene type copolymer rubber material, olefin type copolymer rubber material, natural leather material, artificial leather material, and cloth material. The other members may be constituted of a plurality of materials.

Examples of the process for producing such a laminate include a process of laminating the cross-linked foamed molded article or the compressed cross-linked foamed molded article of the present invention to another member separately molded by, for example, heating or using a chemical adhesive. As the chemical adhesive, known adhesives can be used. Among them, particularly urethane type chemical adhesives, and chloroprene type chemical adhesives are preferable. In lamination using such a chemical adhesive, an undercoat called a primer may be applied in advance.

The cross-linked foamed molded article and the compressed cross-linked foamed molded article of the present invention are good in balance among adhesiveness to another member, foam density, and tensile strength at break. Therefore, the cross-linked foamed molded article or the compressed cross-linked foamed molded article of the present invention can be preferably used in the form of a single layer or multiple layers as, for example, a footwear member such as shoes and sandals, or the like. Examples of the footwear member include midsole, outer sole, and insole. Besides footwear member, the cross-linked foamed molded article and the compressed cross-linked foamed molded article of the present invention can be used for building materials such as heat-insulating material and buffer material.

The present invention is explained in more detail below by way of Examples and Comparative Examples.
(1) Melt Flow Rate (MFR, Unit: g/10 min.)

Measurement was done by A method under the conditions of a temperature of 190° C. and a load of 21.18 N in accordance with JIS K7210-1995.
(2) Density (Unit: kg/m³)

Measurement was done by the immersion method in JIS K7112-1980 after carrying out the annealing described in JIS K6760-1995.
(3) Amount of a Monomer Unit Based on Vinyl Acetate (Unit: wt %)

Measurement was done in accordance with JIS K6730-1995.
(4) Density of a Foamed Molded Article (Unit: kg/m³)

Measurement was done in accordance with ASTM-D297. The smaller this value, the better the light weight properties.
(5) Hardness of a Foamed Molded Article (Unit: none)

Measurement was done by using a C method hardness tester in accordance with ASTM-D2240 with regard to the surface (the face placed on a mold) of the foamed molded article obtained.
(6) Tensile Strength at Break of a Foamed Molded Article (Unit: kg/cm)

The tensile strength at break of a cross-linked foamed molded article was measured in accordance with ASTM-D642. Specifically, the foamed molded article was sliced into a thickness of 10 mm and then punched into the form of No. 3 dumbbell to form a test piece. The test piece was stretched at a velocity of 500 mm/min., and the maximum load F (kg) detected when the test piece was broken was divided by the thickness of the test piece, i.e. 1 cm, to obtain its tensile strength at break. The larger this value, the better the tensile break strength.
(7) Adhesiveness to Another Member

A test piece of 10 cm in length, 2 cm in width, and 1 cm in thickness was cut out from a compressed cross-linked foamed molded article so that a surface of the foamed article may form one surface of the test piece, and the surfaces of the test piece were washed with MEK and dried for 5 minutes at 60° C. A liquid mixture of a primer (‘PE-120’ manufactured by NO-TAPE INDUSTRIAL CO., LTD) and a curing agent (‘Desmodule RFE’ manufactured by Bayer AG in Germany, 5 wt % of the primer) was applied to the test piece surface originating from the surface of the foamed article, and dried for 30 minutes at 60° C. Next, a liquid mixture of an adhesive (‘No. 3410’ manufactured by Bayer AG in Germany) and a curing agent (‘Desmodule RFE’, 2.5 wt % of the adhesive) was applied to the test piece surface on which the primer had been coated in advance, and dried for 5 minutes at 60° C. Then, the test piece and a rubber sheet, which had been coated with a primer (‘P-66’ manufactured by the same company) and dried and then had been coated with a liquid mixture of an adhesive (No. 3410′ manufactured by the same company) and a curing agent (‘Desmodule RFE’, 2.5 wt % of the adhesive) and dried, were laminated and pressed so that the test piece surface coated with the adhesive could come into contact with the rubber sheet surface coated with the adhesive, so that the foamed article and the rubber sheet were bonded. After leaving them for three days at room temperature, the foamed article and the rubber sheet were peeled at a peeling velocity of 50 mm/min. with a 180° peeling tester to measure the adhesion strength of the foamed article with the rubber sheet. Furthermore, the state of peeling was observed and judged as follows.
∘: Material peeling (Destruction has occurred in the foamed article.)
x: Interfacial peeling (Peeling has occurred at the interface between the foamed article and the rubber sheet. Destruction of the foamed article cannot be confirmed.)
(8) Vinyl acetate concentration in a surface and center portion of a foamed article

A square test piece 5 cm long on each side was cut out from a compressed cross-linked foamed molded article, while leaving above and below the face that had been in contact with the lower mold and the face that had been in contact with the cover in producing the foamed molded article. For two points in the testpiece, i.e., the surface originating from the surface of the compressed cross-linked foamed molded article and the center portion of the foam (the central point of thickness direction), a vinyl acetate concentration was measured by the use of ATR method. The vinyl acetate concentration was calculated in accordance with the following equality from the peak strengths at 1740 cm⁻¹ and 1460 cm⁻¹ obtained by ATR method as described on page 601 of Polymer Analysis Handbook (issued by Kinokuniya Co., Ltd. and edited by the Division of Polymer Analysis and Characterization of the Japan Society for Analytical Chemistry):

Vinyl acetate concentration [%]=3.5×A₁₇₄₀/A₁₄₆₀

, wherein A₁₇₄₀ and A₁₄₆₀ indicate respectively peak strengths at 1740 cm⁻¹ and 1460 cm⁻¹.

### EXAMPLE 1

### (1) Preparation of a Thermoplastic Resin Sheet (A-1)

100 parts by weight of an ethylene-vinyl acetate copolymer (COSMOTHENE H2181 manufactured by The Polyolefin Company [MFR=2 g/10 min., density=940 kg/m³, vinyl acetate unit proportion=18 wt %]; hereinafter referred to as EVA (1)), 10 parts by weight of heavy calcium carbonate, 0.5 part by weight of stearic acid, 1.0 part by weight of zinc oxide, 2.8 parts by weight of a thermally decomposable blowing agent (‘Cellmic CE’ manufactured by SANKYO KASEI CO., LTD.), and 0.7 part by weight of dicumyl peroxide were kneaded under conditions of a roll temperature of 120° C. and a kneading time of 5 minutes with a roll kneader, so that a thermoplastic resin sheet (A-1) having a thickness of about 2 mm was obtained.

### (2) Preparation of a Thermoplastic Resin Sheet (B-1)

80 parts by weight of an ethylene-α-olefin copolymer (Excellen GMH GH030 manufactured by Sumitomo Chemical Co., Ltd. [MFR=0.5 g/10 min., density=912 kg/m³]; hereinafter referred to as PE (1)), 20 parts by weight of EVA (1), 10 parts by weight of heavy calcium carbonate, 0.5 part by weight of stearic acid, 1.0 part by weight of zinc oxide, 3.9 parts by weight of a thermally decomposable blowing agent (‘Cellmic CE’ manufactured by SANKYO KASEI CO., LTD.), and 0.7 part by weight of dicumyl peroxide were kneaded under conditions of a roll temperature of 120° C. and a kneading time of 5 minutes with a roll kneader, so that a thermoplastic resin sheet (B-1) having a thickness of 2 mm was obtained.

### (3) Preparation of a Cross-Linked Foamed Molded Article

The above-described thermoplastic resin sheets (A-1) and thermoplastic resin sheets (B-1) were placed in a tray-shaped recessed portion of a lower mold, the tray-shaped recessed portion having a bottom in a square shape 15 cm long on each side and having a depth of 2.0 cm. Regarding a filling method, the sheets were placed in the order from the bottom side of the tray-shaped recessed portion of thermoplastic resin sheets (A-1)/thermoplastic resin sheets (B-1)/thermoplastic resin sheets (A-1)=3 sheets/8 sheets/3 sheets. After the placement, a plate-shaped upper mold and the lower mold were clamped to fill the tray-shaped recessed portion with the thermoplastic resin sheets, and pressurizing and heating were carried out under conditions of a temperature of 160° C., a time of 30 minutes, and a pressure of 130 kg/cm², and then the molds were opened, so that a cross-linked foamed molded article having a thickness of about 40 mm was obtained. Physical property evaluation results of the resultant cross-linked foamed molded article are shown in Table 1.

### (4) Preparation of a Compressed Cross-Linked Foamed Molded Article

The cross-linked foamed molded article obtained in (3) was sliced into a thickness of 30 mm with choice of a portion where the foamed layer originating from the thermoplastic resin sheets (A-1), the foamed layer originating from the thermoplastic resin sheets (B-1), and the foamed layer originating from the thermoplastic resin sheets (A-1) had been laminated in the order. Then, it was cut out into a form of 14 cm×14 cm and was placed in a tray-shaped recessed portion of a lower mold, the tray-shaped recessed portion having a bottom in a square shape 15 cm long on each side and having a depth of 2.0 cm. Then, a plate-shaped upper mold and the lower mold were clamped, and compression was carried out under conditions of a temperature of 155° C., a time of 10 minutes, and a pressure of 150 kg/cm². Subsequently, the molds were cooled to 25° C. and kept for 20 minutes, and then were opened, so that a compressed cross-linked foamed molded article having a thickness of 20 mm was obtained. Physical property evaluation results of the resultant compressed cross-linked foamed molded article are shown in Table 1.

### EXAMPLE 2

### (1) Preparation of a Thermoplastic Resin Sheet (A-2)

100 parts by weight of EVA (1), 10 parts by weight of heavy calcium carbonate, 0.5 part by weight of stearic acid, 1.0 part by weight of zinc oxide, 2.8 parts by weight of a thermally decomposable blowing agent (‘Cellmic CE’ manufactured by SANKYO KASEI CO., LTD.), and 0.7 weight part of dicumyl peroxide were kneaded under conditions of a roll temperature of 120° C. and a kneading time of 5 minutes with a roll kneader, so that a thermoplastic resin sheet (A-2) having a thickness of 2 mm was obtained.

### (2) Preparation of a Thermoplastic Resin Sheet (B-2)

100 parts by weight of PE (1), 10 parts by weight of heavy calcium carbonate, 0.5 part by weight of stearic acid, 1.0 part by weight of zinc oxide, 4.2 parts by weight of a thermally decomposable blowing agent (‘Cellmic CE’ manufactured by SANKYO KASEI CO., LTD.), and 0.7 part by weight of dicumyl peroxide were kneaded under conditions of a roll temperature of 120° C. and a kneading time of 5 minutes with a roll kneader, so that a thermoplastic resin sheet (B-2) having a thickness of 2 mm was obtained.

### (3) Preparation of a Cross-Linked Foamed Molded Article

The above-described thermoplastic resin sheets (A-2) and the thermoplastic resin sheets (B-2) were placed in a tray-shaped recessed portion of a lower mold, the tray-shaped recessed portion having a bottom in a square shape 15 cm long on each side and having a depth of 2.0 cm. Regarding a filling method, the sheets were placed in the order from the bottom side of the tray-shaped recessed portion of thermoplastic resin sheets (A-2)/thermoplastic resin sheets (B-2)/thermoplastic resin sheets (A-2)=3 sheets/8 sheets/3 sheets. After the placement, a plate-shaped upper mold and the lower mold were clamped to fill the tray-shaped recessed portion with the thermoplastic resin sheets, and pressurizing and heating were carried out under conditions of a temperature of 160° C., a time of 30 minutes, and a pressure of 130 kg/cm², and then the molds were opened to, so that a cross-linked foamed molded article having a thickness of about 40 mm was obtained. Physical property evaluation results of the resultant cross-linked foamed molded article are shown in Table 1.

### (4) Preparation of a Compressed Cross-Linked Foamed Molded Article

A compressed cross-linked foamed molded article was obtained from the cross-linked foamed molded article obtained in (3) similarly to the process described in Example 1. Physical property evaluation results of the resultant compressed cross-linked foamed molded article are shown in Table 1.

### COMPARATIVE EXAMPLE 1

### (1) Preparation of a Cross-Linked Foamed Molded Article

100 parts by weight of PVA (1), 10 parts by weight of heavy calcium carbonate, 0.5 part by weight of stearic acid, 1.0 part by weight of zinc oxide, 2.8 parts by weight of a thermally decomposable blowing agent (‘Cellmic CE’ manufactured by SANKYO KASEI CO., LTD.), and 0.7 part by weight of dicumyl peroxide were kneaded under conditions of a roll temperature of 120° C. and a kneading time of 5 minutes with a roll kneader, so that a sheet having a thickness of 2 mm was obtained.

The above sheets were placed in a tray-shaped recessed portion of a lower mold, the tray-shaped recessed portion having a bottom in a square shape 15 cm long on each side and having a depth of 2.0 cm. After the placement, a plate-shaped upper mold and the lower mold were clamped to fill the tray-shaped recessed portion with the thermoplastic resin sheets, and pressurizing and heating were carried out under conditions of a temperature of 160° C., a time of 30 minutes, and a pressure of 130 kg/cm², and then the molds were opened, so that a cross-linked foamed molded article having a thickness of about 40 mm was obtained. Physical property evaluation results of the resultant cross-linked foamed molded article are shown in Table 2.

### (2) Preparation of a Compressed Cross-Linked Foamed Molded Article

A compressed cross-linked foamed molded article was obtained from the cross-linked foamed molded article obtained in (1) similarly to the process described in Example 1. Physical property evaluation results of the resultant compressed cross-linked foamed molded article are shown in Table 2.

TABLE 1

| | | Example 1 | | Example 2 | |
|---|---|---|---|---|---|
| Sheet composition | | A-1 | B-1 | A-2 | B-2 |
| PE(1) | [Weight part] | 0 | 80 | 0 | 100 |
| EVA (1) | [Weight part] | 100 | 20 | 100 | 0 |
| Vinyl acetate concentration | [%] | 17.3 | 3.7 | 17.4 | 0 |

Physical properties of cross-linked foamed
molded article

| Density | [kg/m³] | 98 | 9.5 |
|---|---|---|---|
| Surface hardness | [shore C] | 42 | 41 |
| Physical properties of compressed cross-linked | | | |
| foamed molded article | | | |
| Density | [kJ/mol] | 135 | 135 |
| Strength at break | [kg/cm] | 17.8 | 19.2 |
| Adhesiveness | [N/20 mm] | 81 | 91 |
| | Peeling state | ∘ | ∘ |
| Vinyl acetate concentration | Surface [%] | 8.2 | 8.4 |
| | Center portion [%] | 2.2 | 0.1 |
| Vinyl acetate concentration | Surface/ | 3.7 | 84.0 |
| ratio | Center portion | | |

TABLE 2

| | | Comparative | Comparative | Comparative |
|---|---|---|---|---|
| Sheet composition | | Example 1 | Example 2 | Example 3 |
| PE(1) | [Weight part] | 0 | 100 | 60 |
| EVA (1) | [Weight part] | 100 | 0 | 40 |
| Vinyl acetate concentration | [%] | 17.4 | 0 | 6.9 |
| Physical properties of cross-linked foamed molded article | | | | |
| Density | [kg/m³] | 139 | 93 | 103 |
| Surface hardness | [shore C] | 43 | 42 | 42 |
| Physical properties of compressed cross-linked foamed molded article | | | | |
| Density | [kJ/mol] | 195 | 134 | 148 |
| Strength at break | [kg/cm] | 15.8 | 20.9 | 18.2 |
| Adhesiveness | [N/20 mm] | 83 | — | 83 |
| | Peeling state | ∘ | x | ∘ |
| Vinyl acetate concentration | Surface [%] | 8.5 | 0.3 | 5.3 |
| | Center portion [%] | 8.6 | 0.2 | 5.1 |
| Vinyl acetate concentration ratio | Surface/Center portion | 1.0 | 1.5 | 1.0 |

### INDUSTRIAL APPLICABILITY

The present invention can provide a process for producing a cross-linked foamed molded article, the surface of which is different in properties from the inside of the foamed molded article, without passing through a step of modifying the surface of the foamed molded article; the cross-linked foamed molded article obtained by the process; a footwear member having a layer consisting of the cross-linked foamed molded article; and a footwear having the footwear member.

1. A process for producing a cross-linked foamed molded article by the use of a lower mold having a tray-shaped recessed portion and an upper mold capable of closing the tray-shaped recessed portion, which process comprises the following steps:
(1) a step of stacking a thermoplastic resin sheet (A) comprising a blowing agent and a cross-linking agent and a thermoplastic resin sheet (B) comprising a blowing agent and a cross-linking agent and differing in resin composition from the thermoplastic resin sheet (A) in the tray-shaped recessed portion, and clamping the upper mold and the lower mold to fill the tray-shaped recessed portion with the thermoplastic resin sheet (A) and the thermoplastic resin sheet (B),
(2) a step of pressurizing and heating the clamped shaping molds, and
(3) a step of opening the molds to obtain a foamed molded article.

2. The process for producing a cross-linked foamed molded article according to claim 1, wherein the thermoplastic resin sheet (A) and the thermoplastic resin sheet (B) satisfy the following conditions a) and b):
a) a thermoplastic resin constituting the thermoplastic resin sheet (A) and thermoplastic resin sheet (B) is an ethylene-based resin and/or an ethylene-unsaturated ester-based copolymer having a monomer unit based on ethylene and a monomer unit based on at least one unsaturated ester selected from the group consisting of a carboxylic acid vinyl ester and an unsaturated carboxylic acid alkyl ester, and
b) the ester group concentration in the sheet (A) is higher than that in the sheet (B).

3. The process for producing a cross-linked foamed molded article according to claim 2, wherein, in the step (1), the thermoplastic resin sheet (A) and the thermoplastic resin sheet (B) are stacked so that the thermoplastic resin sheets (A) may be positioned at both ends of thickness direction and the thermoplastic resin sheet (B) may be positioned between the thermoplastic resin sheets (A).

4. The process for producing a cross-linked foamed molded article according to claim 1, which process uses the upper mold and the lower mold both preheated.

5. A cross-linked foamed molded article in which an ethylene-based resin and an ethylene-unsaturated ester-based copolymer having a monomer unit based on ethylene and a monomer unit based on at least one unsaturated ester selected from a carboxylic acid vinyl ester and an unsaturated carboxylic acid alkyl ester are cross-linked, which article satisfies the following requirements (i) and (ii):
(i) an ester group concentration of a surface of the foamed article is equal to or more than 4%, and
(ii) the ester group concentration of a surface of the foamed article is at least twice higher than the ester group concentration of a center portion of the foamed article, or the ester group concentration of a center portion of the foamed article is 0.

6. A cross-linked foamed molded article obtained by the production process according to claim 1.

7. A compressed cross-linked foamed molded article obtained by compression molding the cross-linked foamed molded article according to claim 5.

8. A footwear member comprising a layer formed of the cross-linked foamed molded article according to claim 5 or the compressed cross-linked foamed molded article according to claim 7.

9. A footwear comprising the footwear member according to claim 8.
